(19) United States
(12) Patent Application Publication
(10) Pub. No.: US 2004/0116186 A1
(43) Pub. Date: Jun. 17, 2004

(54) Distance based distributed online game server system

(76) Inventors: Kwang-Hyun Shim, Daejon (KR); Il-Kyu Park, Daejon (KR); Jaeyong Chung, Daejon (KR); Eun-Hee Lee, Daejon (KR); Jong-Sung Kim, Daejon (KR); Byoung-Tae Choi, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/729,477

(22) Filed: Dec. 5, 2003

(30) Foreign Application Priority Data
Dec. 13, 2002 (KR) 2002-79863

(51) Int. Cl. G06F 19/00; G06F 17/00

(52) U.S. Cl. 463/42

(57) ABSTRACT

A distance based distributed online game server system is disclosed. The distance based distributed online game server system provides online game of an imaginary game world with various characters by dividing the imaginary game world into a plurality of regions and managing online game based on the regions. The distance based distributed online game server system includes a session server for providing information including region information; a database server 102 for managing player information and transmitting corresponding player information to the session server; a non-player character (NPC) server for managing data and processing scripts of non-player character by artificial intelligence; a game server for providing a game service to payers within a region assigned by the session server according to the region information and managing the game of region by dividing the region into cells; and a real-time download server for provides a real-time downloading service to the player.

### FIELD OF THE INVENTION

The present invention relates to a distance based distributed online game service system; and, more particularly, to a distance based distributed online game service system supporting larger number of online game players by distributing game servers based upon distance effectively.

### DESCRIPTION OF THE PRIOR ART

Multi-player online games are computer games played by a large number of players through a communication network such as the Internet. The players interact with each other in the multi-player online game. Lately, it is required that the multi-player online game system supports synchronization of game players, graphic effect technology, networking technology and server distributing technology for decreasing system load.

However, as the number of players increases, an existing multi-player online game server system has utilized additional servers. As a result, an access to the server is not stable because the multi-player online game server system cannot distribute system load efficiently.

### SUMMARY OF THE INVENTION

It is, therefore, an object of the present invention to provide a distance based distributed online game server system supporting larger number of online game players by distributing game servers based upon distance effectively.

In accordance with an aspect of the present invention, there is provided a distance based distributed online game server system for providing online game of an imaginary game world with various characters by dividing the imaginary game world into a plurality of regions and managing online game based on the regions, the distance based distributed online game server system including: a session server for authenticating a player and providing information including region information and character information, wherein the character information has information of game character selected by the player; a database server 102 for managing player information including account information of the player and character information and transmitting corresponding player information to the session server when the session server requests to have player information of a player; a non-player character (NPC) server for managing data and processing scripts of non-player character by artificial intelligence, wherein the non-player character is a game character that are not selected by the player; a game server for providing a game service to payers within a region assigned by the session server according to the region information and managing the game of region by dividing the region into cells; and a real-time download server for provides a real-time downloading service to the player.

### BRIEF DESCRIPTION OF THE DRAWINGS

The objects and features of the present invention will become apparent from the following description of preferred embodiments given in conjunction with the accompanying drawings, in which:

FIG. 1 is a block diagram showing a distance based distributed online game server system in accordance with a preferred embodiment of the present invention;

FIG. 2 is a block diagram illustrating a game server in distance based distributed online game server system in accordance with the present invention; and

FIG. 3 is a flowchart for explaining a log-in method in distance based distributed online game server system in accordance with the present invention.

### DETAILED DESCRIPTION OF THE PREFERRED EMBODIMENTS

A virtual game environment is divided into an imaginary game world, a region and a cell based upon distance.

The world is independent environment physically and logically in a multi-player online game. That is, information such as event information or character information is exchanged between different online game players in the same world. However, online game players from different worlds cannot exchange the event information or the character information. Also, the world includes more than one region in the multi-player online game. The region is supported by one server and provides scalability in the multi-player online game. Again, the region includes more than one cell in the multi-player online game. Because the environment of the multi-player online game is categorized into the world, the region and the cell based upon distance between online game players, the distance based distributed online game service system is proposed in accordance with the present invention.

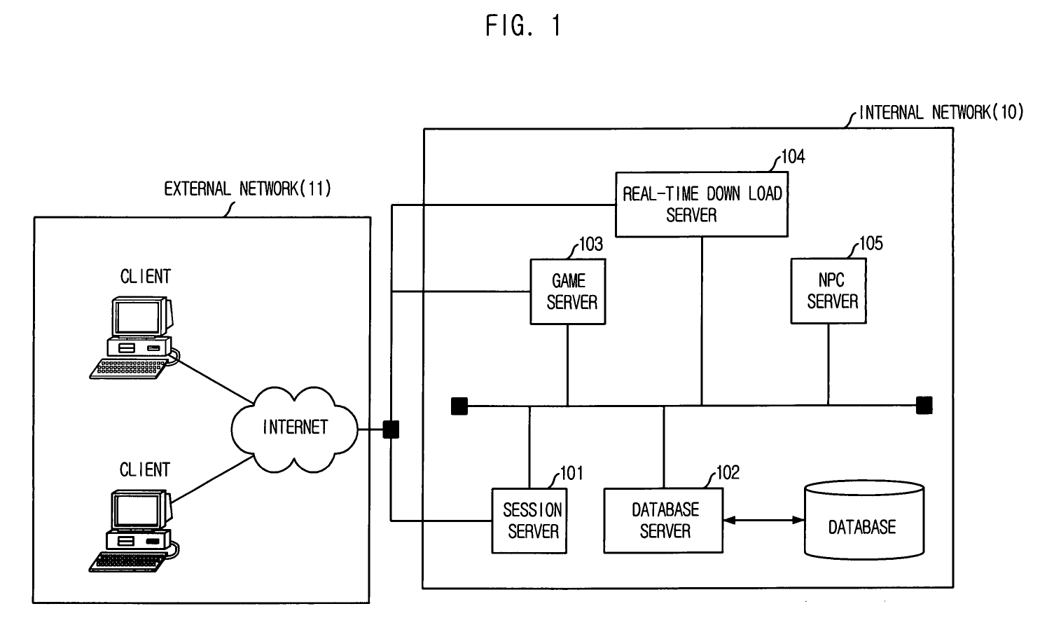

FIG. 1 is a block diagram showing a distance based distributed online game server system in accordance with an embodiment of the present invention.

Referring to FIG. 1, the distance based distributed online game server system in accordance with an embodiment of the present invention includes a session server 101, a database server 102, a game server 103, a real-time download server 104 and a non-player character(NPC) server 105. The session server 101, the real-time server 104 and the game server 103 are connected to an external network 11. The session server 101, the real-time server 104, the game server 103, the data server 102 and the NPC server 105 is connected to an internal network 10.

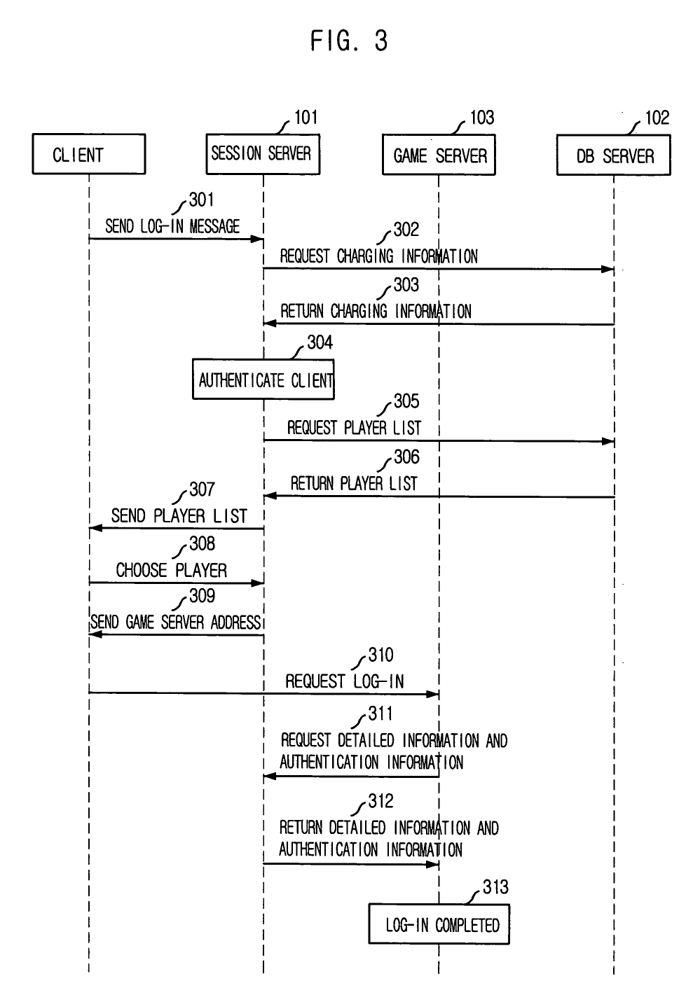

The session server 101 authenticates a player and provides information of available worlds. The session server 101 also provides information such as a server address and a port number so that the player can access to the game server 103. The session server 101 is also called a log-in/log-out server. A log-in method is explained in FIG. 3.

The database server 102 manages every data that does not need a real-time process and has a cache server for processing data that is used frequently. The data that the database server 102 manages are account information and detailed information of the player.

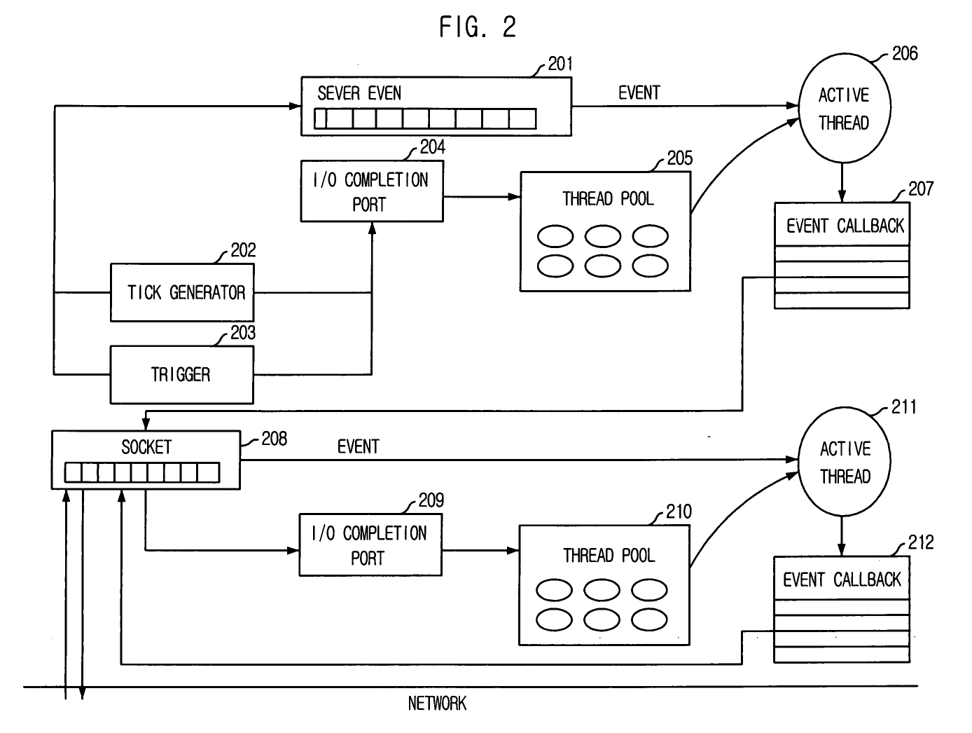

The game server 103 allocates identification to a game player so that the player can obtain character information from the real-time download server 104 or from the database server 102. An operating procedure of the game server 103 is explained in FIG. 2.

System load is distributed effectively and large number of players can share the service because each server, the session server 101, the database server 102 and the NPC server 105, can manage a plurality of game servers 103, and one game server 103 operates one region based upon distance. Also, reliability is obtained because a transmission control protocol (TCP) or a reliable user datagram protocol (RUDP) is used in communication between the player and the game server 103. Again, system load can be reduced by using an area of interest method and a dead reckoning method.

The game server 103 manages cells within or near the area of interest of the player according to the area of interest method. That is, the region is divided into cells based upon distance and the area of interest includes the cell of the player and neighbor cells of the player. The neighbor cells may include cells in other region.

Changes of each character are transferred to a character that is in the area of interest during online game. Therefore, network load is reduced because players receive or transmit character information of other players who are in the area of interest of the players.

Meanwhile, movements or changes of objects in the online game are updated and predicted automatically during the online game. If every movement and change is transferred to the game server 103, network load definitely increases. In order to decrease the network load, communication between the game server 103 and the player is reduced.

For example, if an object started an operation of ‘walking’, information of walking direction and speed is delivered to the player. The game server 103 and the player compute a current position and property of the object by using the information of walking direction and speed of the player at a predetermined time. Therefore, movements or changes of characters are not synchronized but predicted within a limit of error during the online game.

The player can obtain real-time data by using the real-time download server 104. The NPC server 105 manages data and script information of game characters that are not chosen by the players by using artificial intelligence.

The NPC server 105 manages a plurality of game servers 103 by communicating in the internal network 10. An event that is transferred from the NPC server 105 to the game server 103 is not separated from an event that is transferred from the player to the game server 103 and also an event that is transferred from the game server 103 to the NPC server 105 is not separated from an event that is transferred from the game server 103 to the player because the kind of events that the NPC server 105 manages are different from the kind of events that the player manages. Therefore, system load of game server 103 is reduced because events are not separated in the internal network 10 and the external network 11.

FIG. 2 is a block diagram illustrating a game server in distance based distributed online game service system in accordance with the present invention.

Referring to FIG. 2, the game server 103 includes a first input/output completion port 204 for processing events periodically received from a tick generator 202 and a trigger 203 and a second input/output completion port 209 for processing events received from a socket 208 through network.

Once the socket 208 of the game server 103 receives an event through the network, an event processing function is called. A thread is allocated for processing the event. However, it is not efficient to generate a new thread every time an event occurs. Therefore, the game server 103 includes thread pools 205 and 210 that have various threads. An available thread is used for processing an event and returned to the thread pools 205 and 210.

Basic information for playing a game is transferred as events and Properties of other objects are transferred by real-time data structure. Also, the NPC servers 105, the database server 102 and real-time download server 104 process events by using the thread pool method.

FIG. 3 is a block diagram showing a log-in method in distance based distributed online game server system in accordance with the present invention.

At step 301, a player sends a log-in message to access to the session server 101. At step 302, the session server 101 requests account information to the database server 102. At step 303, the database server 102 returns the account information to the session server 101 by using identification of the player. At step 304, the session server 101 authenticates the player. At step 305, the session server 101 requests a player list to the database server 102. At step 306, the database server returns the player list to the session server 101. At step 307, the session server 101 delivers the player list to the player. At step 308, the player picks an opponent player and returns the player information to the session server 101.

At step 309, the session server 101 sends an address of an available game server 103. At step 310, the player requests to log in to the game server 103. At step 311, the game server 103 requests detailed information and authentication information to the session server 101. At step 312 the session server returns the detailed information and the authentication information to the game server 103. At step 313, the game server 103 completes a log-in process of the player by using the detailed information and the authentication information and initiates a game.

As mentioned above, the present invention efficiently distribute system load by dividing online game environment into regions based upon distance in the multi-player online game server system even though the conventional server system utilizes additional servers as the number of game players increases.

Also, the present invention can obtain reliability for communication between the game server and the game players by using the TCP and the reliable UDP. Again, the present invention can efficiently decrease the system load by using the area of interest method and the dead reckoning method.

Also, the present invention can decrease the system load by processing information of players who are not taking participated in the online game at the NPC server.

While the present invention has been described with respect to the particular embodiments, it will be apparent to those skilled in the art that various changes and modifications may be made without departing from the spirit and scope of the invention as defined in the following claims.

What is claimed is:

1. A distance based distributed online game server system for providing online game of an imaginary game world with various characters by dividing the imaginary game world into a plurality of regions and managing online game based on the regions, the distance based distributed online game server system comprising:
a session server for authenticating a player and providing information including region information and character information, wherein the character information has information of game character selected by the player;
a database server 102 for managing player information including account information of the player and character information and transmitting corresponding player information to the session server when the session server requests to have player information of a player;
a non-player character (NPC) server for managing data and processing scripts of non-player character by artificial intelligence, wherein the non-player character is a game character that are not selected by the player;
a game server for providing a game service to payers within a region assigned by the session server according to the region information and managing the game of region by dividing the region into cells; and
a real-time download server for provides a real-time downloading service to the player.

2. The distance based distributed online game server system as recited in claim 1, wherein the session server provides the region information including a server address and a port number of the game server assigned to a player within corresponding region.

3. The distance based distributed online game server system as recited in claim 1, wherein the game server is managed by the NPC server, the database server and the session server.

4. The distance based distributed online game server system as recited in claim 1, wherein when a region is added, a game server is added to manage the region.

5. The distance based distributed online game server system as recited in claim 1, wherein a transmission control protocol (TCP) or a reliable user datagram protocol (RUDP) is used in communication between the player for obtaining reliability of the system and an area of interest method is used for reducing system load.

6. The distance based distributed online game server system as recited in claim 1, wherein movements or changes of characters are predicted by dead-reckoning within a limit of error.
